(19) United States
(12) Patent Application Publication
(10) Pub. No.: US 2010/0219835 A1
(43) Pub. Date: Sep. 2, 2010

(54) Non-magnetic transmitter housing

(76) Inventor: Steven W. Wentworth, Fountain Hills, AZ (US)

Correspondence Address: Philip G. Meyers Law Office, Suite 300, 1009 Long Prairie Road, Flower Mound, TX, 75022, US

(21) Appl. No.: 12/653,282

(22) Filed: Dec. 10, 2009

Related U.S. Application Data
(60) Provisional application No. 61/201,394, filed on Dec. 10, 2008.

(51) Int. Cl. G01V 3/08

(52) U.S. Cl. 324/346

(57) ABSTRACT

A sonde assembly of the invention includes: a sonde housing in the form of a non-magnetic tube having windows therein for permitting a radio signal to be transmitted out the tube from the inside;

means such as a device enclosing a front end of the tube; a sonde slidingly disposed inside the non-magnetic tube and closely fitting in a sonde cavity thereof in engagement with a front end stop of the tube. The sonde comprises a sensor and a radio transmitter connected to the sensor to transmit a directional signal based on sensor input, which sensor and transmitter are disposed inside a non-magnetic cylinder.

This application claims priority of U.S. provisional application Ser. No. 61/201,394 filed Dec. 10, 2008.

### FIELD OF THE INVENTION

The present invention relates to direction al drilling systems wherein a transmitter built into a sonde housing is used to transmit information concerning the drill head.

### BACKGROUND OF THE INVENTION

Recently the world's leading manufacturer of radio transmitter beacons for use in horizontal directional boring, Digital Control Incorporated, or DCI, introduced a new locating system. The system reads the earth's magnetic field rather than gravity. With this information, the system is able to do a superior job of locating the buried drill head tooling when compared to conventional walkover receiver/transmitter systems. See for example the “compass effect” and non-magnetic drill tool housing 282 as described in U.S. Patent Application 20050077085, Apr. 14, 2005, the contents of which are incorporated by reference herein.

The superiority of the new SST (as it is trade-named) is realized when boring underneath busy streets, rivers or other locations where a walkover transmitter may be imperiled by traffic, need for a boat, or the signal may be affected by the existence of steel rebar between the receiver and the transmitter. However, to operate, the SST transmitter must be housed and located at a substantial distance (preferably at least about 10 feet) from any magnetic item, including alloy steel making up the housing or drill stem. Most steel alloys commonly used to make sonde housings are sufficiently magnetic to prevent the SST from sensing the earth's magnetic field accurately. To remedy this, non-magnetic variations of stainless steel can be used, including 15-15HS Max from Carpenter or Monel K-500 from Specialty Metals Corporation. These alloys are presently the only ones that have marginally enough tensile strength to handle stresses developed in drilling conditions, therefore the sonde housing design must be done with minimization of stress risers in mind.

Additionally, these alloys are extraordinarily difficult to fabricate into tooling as they have a low machineability rating. This means the design is best simplified to accommodate these difficulties. A general design to do that does exist in the industry. It is known as an end load, meaning the drill stem is removed from the transmitter housing to access the transmitter (sonde) for loading/unloading through the end of the housing.

Normally during loading, the sonde must be clocked, meaning oriented rotationally to the steering features on the bit mounted forward of the housing. One of the technical innovations of the SST transmitter is that it can be electronically clocked to the steering feature. This means the transmitter must remain solidly locked into a given orientation once it is installed; but it can be installed randomly in orientation to the steering feature.

End load housings normally restrain and clock the transmitter by having a slot in the transmitter face engage a tabbed feature in the housing. The transmitter is then trapped from the opposite end with a plug which maintains the tab/slot engagement and therefore the clock orientation.

The action of finding and engaging the slot and the tab is risk prone as it can't be inspected at the bottom of its blind bore, a bore possibly contaminated with dried mud. Should this engagement not be accomplished, the transmitter can drift in rotation during operation and the drill head will go off course, the ramifications of which are many, least of which is need to start the bore over.

### SUMMARY OF THE INVENTION

A sonde assembly of the invention includes: a sonde housing in the form of a non-magnetic tube having windows therein for permitting a radio signal to be transmitted out the tube from the inside;

means such as a device enclosing a front end of the tube; a sonde slidingly disposed inside the non-magnetic tube and closely fitting in a sonde cavity thereof in engagement with a front end stop of the tube. The sonde comprises a sensor and a radio transmitter connected to the sensor to transmit a directional signal based on sensor input, which sensor and transmitter are disposed inside a non-magnetic cylinder.

A rear end cap is secured in a fixed position in a rear end opening of the non-magnetic tube, and a connector rigidly connects a rear end portion of the cylinder to a front end portion of the rear end cap. Upon securing of the rear end cap in a rear end opening of the sonde housing, the sonde is secured in a fixed position relative to the sonde housing. Preferably the sonde includes a sensor that senses the magnetic field of the earth.

### BRIEF DESCRIPTION OF THE DRAWINGS

In the accompanying drawing, wherein like numerals denote like elements.

FIG. 1 is a side view of a drill head using a sonde assembly of the invention,

FIG. 2 is a lengthwise sectional view of the drill head of FIG. 1 along the line A-A in FIG. 1,

FIG. 3 is an enlarged view of the circled area B in FIG. 2,

FIG. 4 is an enlarged view of the circled area C in FIG. 2,

FIG. 5 is an enlarged view of the circled area D in FIG. 4,

FIG. 6 is a partial side view of a sonde assembly of the invention;

FIG. 7 is a rear view, partly in section, of the sonde assembly of FIG. 6,

FIG. 8 is a top view of the sonde assembly of FIG. 6,

FIG. 9 is a side view partly in section, of the sonde assembly of FIG. 6, and

FIG. 10 is an enlarged view of the circled area E in FIG. 9.

### DETAILED DESCRIPTION

A sonde mounting concept applied with the present invention as described herein eliminates risk of not engaging the tab into the slot by rigidly bolting the sonde to a plug which threadedly retains the sonde in its cavity. The concept is simple yet elegant. It eliminates risk of rotational drift, simplifies installation and provides the operator with complete confidence in the security of the sonde.

The details used are not limited to applications where a non magnetic housing is required. However, at this time, the only transmitter existing that can electronically clock is the SST unit that senses the earth's magnetic field for orientation. In the future, as gravity sensing transmitters evolve, such units may also be able to use electronic clocking, making this concept of this invention applicable for that technology as well.

In the accompanying drawings, Steering bill 906-5255 is a conventional flat bill made of non-magnetic steel. Such bills made of alloy steel have been used in the industry for over 15 years. Bill Adapter 906-5256 mounts that bill with bolts on an angled face to facilitate steering. The adapter joins to the housing via a conventional tapered API thread. The adapter has a central fluid passage 30 and a discharge nozzle 906-5259 to meter drilling mud to the bill area. Both adapter and housing are made of a non-magnetic metal (steel) for use in the present invention.

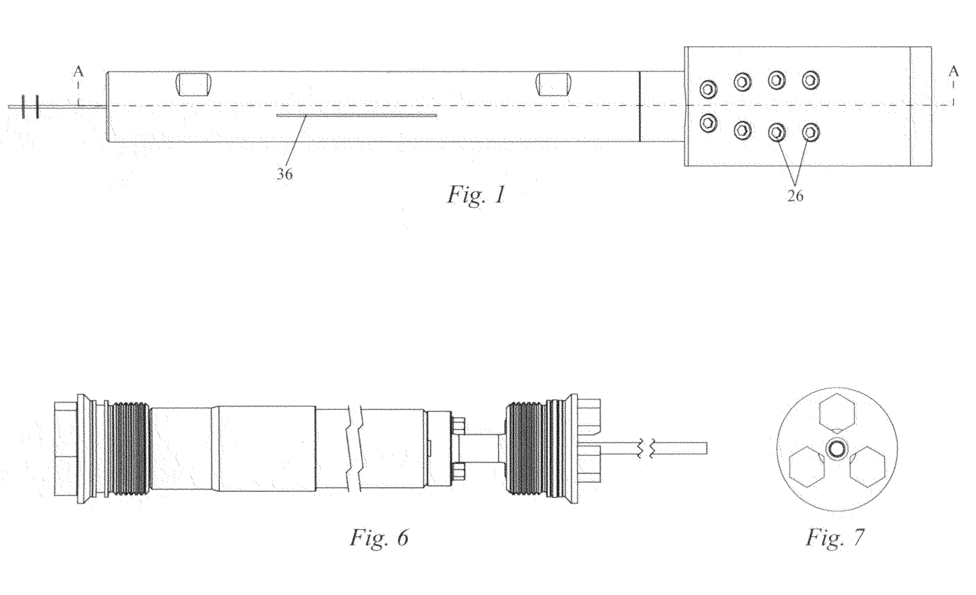

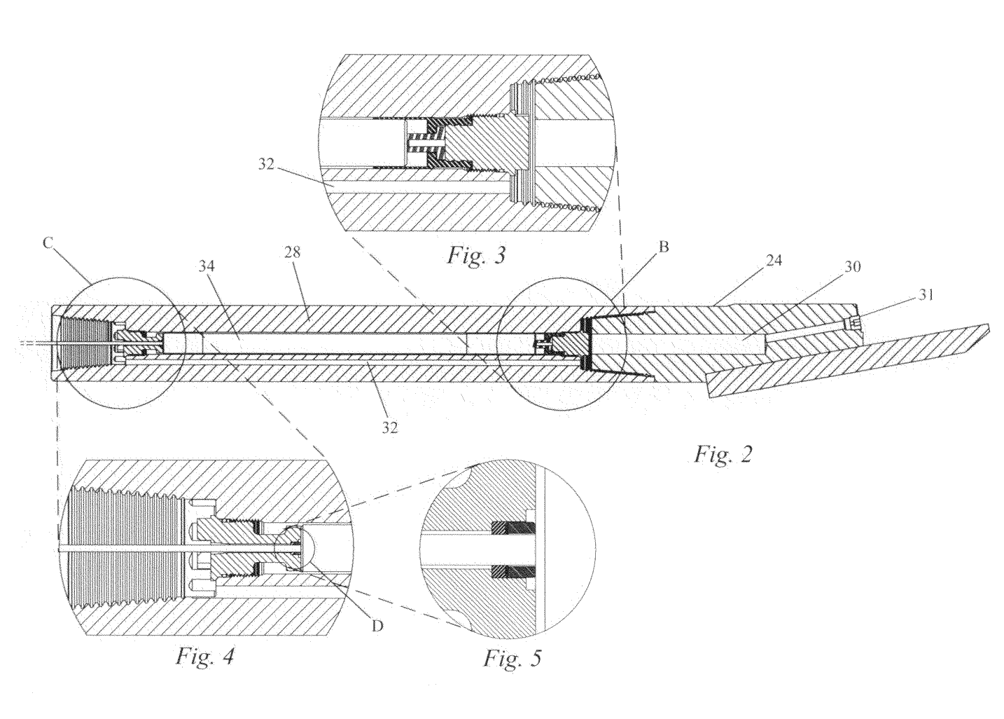

The Housing 906-5233 has nine longitudinal fluid passages 32 that direct the drill mud around the central sonde cavity. One of these passages is shown below the sonde cavity in FIG. 2, and the others are configured like the one shown but arranged in a circular formation around the sonde cavity. The sonde cavity is vented to the outside ground pressure through three radio transmission slots (one visible in FIG. 1). These slots may be open, or they may be sealed with putty that will yield and leak should modest differential pressures develop between the sonde cavity and the adjacent soil. The transmitter cavity is, however, sealed from the flow of pressurized mud. These seals are located on plugs at each and of the cavity and around the data transmission cable that extends from the rear of the sonde and continues through the length of the drill stem up to the machine. The front plug assembly 906-5250 has a cushioned nose to provide a small amount of shock isolation as well as o-ring 906-5235 to seal. The plug threads into the housing body itself. It is considered a semi-permanent installation, only being removed to service the concentric sleeve 906-5249 or the elastic isolator 906-5251.

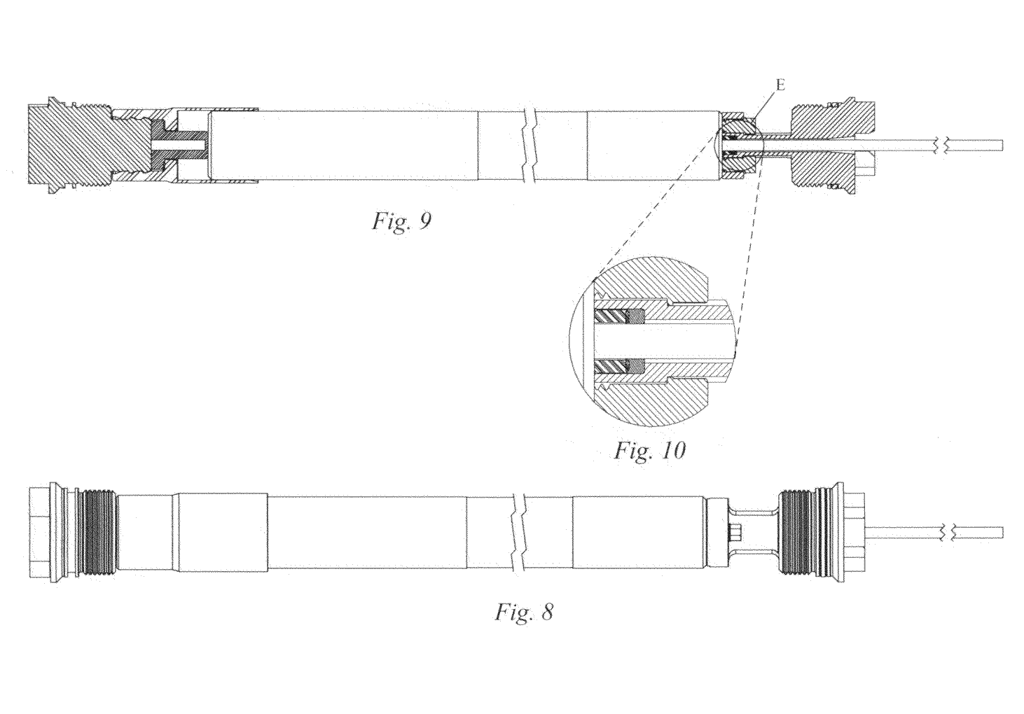

The Rear Plug 906-5237 is more involved in securing the transmitter than the front plug. It mounts to the rear face of the transmitter by means of (2) bolts threading into tapped holes in the rear sonde face. Note that the action of tightening these (2) mounting bolts compresses an o-ring and packing to seal the pressurized fluid from entering the sonde or sonde cavity. These two bolts are located 180° apart and can be seen as the smaller hexes in FIGS. 6 and 8.

FIGS. 6-9 show the sub assembly of the SST transmitter with the housing removed, with the front on the left. Mounting the sub assembly of the SST transmitter and the rear plug and mounting bolts into the housing body is done by rotating the sub assembly as a unit to engage the threads at the rear of the sonde cavity. The external threads on the rear plug securely engage the threads at the rear of the sonde cavity. The assembly is driven via one of the three ½″ hexes (bosses on the rear face of the rear cap) with a socket and socket extension. The O-ring 906-5240 seals as the plug tightens up against the housing, and the sonde is restrained in all directions as well as sealed from pressurized mud flow.

In summary, the front plug remains in place sealing the front end of the sonde cavity. Use of a blind tube instead of a front plug is possible but involves practical difficulties in accessing and cleaning the sonde cavity. The rear plug has a large diameter threaded rear portion which allows attachment of the sub assembly to the sonde housing as described above, and a forwardly extending extension ending in an annular flange that abuts against the rear end face of the sonde housing. The bolts shown in FIGS. 6-9 extend through two holes in the annular flange of the extension into receiving threaded holes in the end of the cylinder that encloses the sonde. By this means the sub assembly, the sonde housing and rear cap, rotate as a unit.

The drill head is threadedly attached to a non magnetic drill stem extension often known as a collar. This extension provides at least 12 feet of distance between the back of the housing and the start of the magnetic steel stem.

Removal of the sonde from the cavity is done in reverse by removing the 12 foot drill stem collar from the rear of the housing and unthreading the rear plug. Along with the plug, the sonde will be extracted. The foregoing design has been tested and proved to be functional, easily used and manufacturable, making good use of the difficult to machine non magnetic stainless steel. 906-5250 has a cushioned nose to provide a small amount of shock isolation as well as o-ring 906-5235 to seal. The plug threads into the housing body itself. It is considered a semi-permanent installation, only being removed to service the concentric sleeve 906-5249 or the elastic isolator 906-5251.

The Rear Plug 906-5237 is more involved in securing the transmitter than the front plug. It mounts to the rear face of the transmitter by means of (2) bolts threading into tapped holes in the rear sonde face. Note that the action of tightening these (2) mounting bolts compresses an o-ring and packing to seal the pressurized fluid from entering the sonde or sonde cavity. These two bolts are located 180° apart and can be seen as the smaller hexes in FIG. 6.

FIGS. 6-9 show the sub assembly of the SST transmitter with the housing removed, with the front on the left. Mounting the sub assembly of the SST transmitter and the rear plug and mounting bolts into the housing body is done by rotating the sub assembly as a unit to engage the threads at the rear of the sonde cavity. The external threads on the rear plug securely engage the threads at the rear of the sonde cavity. The assembly is driven via one of the three ½″ hexes (bosses on the rear face of the rear cap) with a socket and socket extension. The O-ring 906-5240 seals as the plug tightens up against the housing, and the sonde is restrained in all directions as well as sealed from pressurized mud flow.

In summary, the front plug remains in place sealing the front end of the sonde cavity. Use of a blind tube instead of a front plug is possible but involves practical difficulties in accessing and cleaning the sonde cavity. The rear plug has a large diameter threaded rear portion which allows attachment of the sub assembly to the sonde housing as described above, and a forwardly extending extension ending in an annular flange that abuts against the rear end face of the sonde housing. The bolts shown in FIGS. 6-9 extend through two holes in the annular flange of the extension into receiving threaded holes in the end of the cylinder that encloses the sonde. By this means the sub assembly, the sonde housing and rear cap, rotate as a unit.

The drill head is threadedly attached to a non magnetic drill stem extension often known as a collar. This extension provides at least 12 feet of distance between the back of the housing and the start of the magnetic steel stem.

Removal of the sonde from the cavity is done in reverse by removing the 12 foot drill stem collar from the rear of the housing and unthreading the rear plug. Along with the plug, the sonde will be extracted. The foregoing design has been tested and proved to be functional, easily used and manufacturable, making good use of the difficult to machine non magnetic stainless steel.

While certain embodiments of the invention have been illustrated for the purposes of this disclosure, numerous changes in the method and apparatus of the invention presented herein may be made by those skilled in the art, such changes being embodied within the scope and spirit of the present invention as defined in the appended claims.

1. A sonde assembly, comprising:
a sonde housing in the form of a non-magnetic tube having windows therein for permitting a radio signal to be transmitted out the tube from the inside;
means for enclosing a front end of the tube;
a sonde slidingly disposed inside the non-magnetic tube and closely fitting in a sonde cavity thereof in engagement with a front end stop of the tube, the sonde comprising a sensor and a radio transmitter connected to the sensor to transmit a directional signal based on sensor input, which sensor and transmitter are disposed inside a non-magnetic cylinder;
a rear end cap securable in a fixed position in a rear end opening of the non-magnetic tube; and
a connector rigidly connecting a rear end portion of the cylinder to a front end portion of the rear end cap, whereby upon securing of the rear end cap in a rear end opening of the sonde housing, the sonde is secured in a fixed position relative to the sonde housing.

2. The assembly of claim 1, wherein the sensor senses the magnetic field of the earth.

3. The assembly of claim 1, wherein the connector comprises a forwardly extending extension of the rear cap.

4. The assembly of claim 1, wherein the enclosing means comprises front cap securable in a fixed position in a front end opening of the non-magnetic tube.

5. The assembly of claim 1, wherein the non-magnetic tube consists essentially of a non-magnetic stainless steel.

6. The assembly of claim 1, wherein the connector comprises a frontwardly extending extension of the rear cap having a lesser diameter than a threaded rear portion of the rear cap, which threaded rear portion engages threads on the inner periphery of the nonmagnetic tube.

7. The assembly of claim 1, wherein the frontwardly extending extension of the rear cap further comprises a front end flange having holes therethrough, the sonde cylinder has rearwardly opening holes therein alignable with the holes in the flange of the rear cap, and bolts are used to secure the rear cap to the sonde cylinder.
